(19) United States
(12) Patent Application Publication
(10) Pub. No.: US 2012/0092126 A1
(43) Pub. Date: Apr. 19, 2012

(54) Biometric Module for Vehicle Access Control

(76) Inventor: James S. Bianco, Suffield, CT (US)

(21) Appl. No.: 13/273,585

(22) Filed: Oct. 14, 2011

Related U.S. Application Data
(60) Provisional application No. 61/393,612, filed on Oct. 15, 2010.

(51) Int. Cl. G08B 29/00; G06K 7/01

(52) U.S. Cl. 340/5.52; 235/439

(57) ABSTRACT

A biometric module for a vehicle access control employs a base assembly and a cover assembly which is pivotally mounted to the base assembly. The cover assembly forms a chute and has an access opening at one end. A bio-reader, which is preferably a fingerprint reader, is located adjacent the access opening and is carried by the cover assembly. A sensor senses the presence of a vehicle and actuates a switch for the blower. A heater is also employed to maintain a temperature range for the bio-reader.

### CROSS-REFERENCE TO RELATED APPLICATION

This application claims the priority of U.S. Provisional Patent Application No. 61/393,612 filed on Oct. 15, 2010, the disclosure of which is incorporated herein in its entirety.

### BACKGROUND

This disclosure relates generally to electronic devices which are employed for identification purposes. More particularly, this disclosure relates to modules which employ electronic processing to identify individuals by means of an image of a fingerprint or a thumbprint.

A number of devices and techniques have been proposed for automatically controlling access for various facilities. Because of the uniqueness of fingerprints, various devices have been constructed for electronically processing the image of a fingerprint and using the analysis to control access to a facility. One of the problems associated with such electronic processing is the ease with which the sensor may be employed and the steps taken to ensure the integrity of the image of the sensed digit. The integrity of the image can be problematic in outdoor or semi-outdoor environments when the elements and weather conditions may adversely affect the sensing function.

In addition, the positioning and location of an electronic module which senses the image of a fingerprint to provide controlled access is problematic for applications wherein it is desired to obtain access to a vehicle lot or facility while the individual remains seated in a normal position in the vehicle.

### SUMMARY

Briefly stated, a biometric module comprises a base assembly and a cover assembly mounted to the base assembly. The cover assembly has a chute with an access opening at one end. The chute is angularly pivotal relative to the base. A bio-reader is carried by the cover assembly and located adjacent the access opening. A blower generates a flow of air through the chute and across the bio-reader. A switch actuates the blower.

A heater is employed for the bio-reader. The bio-reader is preferably a fingerprint reader. A rotator rotatably mounts the cover assembly to the base assembly and also defines an air channel between the blower and the chute. A temperature sensor senses ambient temperature and the heater is controlled in response to the ambient temperature. A microprocessor receives data from the bio-reader and generates an output signal to a gate control. A vehicle sensor which provides a vehicle detection input to the microprocessor wherein the blower is operated in response to the vehicle detection input. The cover assembly and the base further comprise a limiter to limit angular pivoting of the cover assembly relative to the base.

In one embodiment, the cover assembly comprises a transparent cover.

### BRIEF DESCRIPTION OF THE DRAWINGS

FIG. 1 is a perspective view of a biometric module;

FIG. 2 is a perspective view of the biometric module of FIG. 1, taken generally from the right thereof;

FIG. 3 is an exploded perspective view, portions removed, of the biometric module of FIG. 1;

FIG. 4 is an exploded perspective view of a blower/bracket subassembly of the biometric module of FIG. 1;

FIG. 5 is a partially exploded perspective view of a blower/heater controller/blower subassembly of the biometric module of FIG. 1;

FIG. 6 is an assembly view of the controller/blower subassembly of FIG. 5;

FIG. 7 is an exploded view of a reader subassembly for the biometric module of FIG. 1;

FIG. 8 is an exploded view of a rotation subassembly for the biometric module of FIG. 1;

FIG. 9 is a perspective view of the assembled subassembly of FIG. 8;

FIG. 10 is a perspective view of the assembled subassembly of FIG. 9 from an opposite view thereof;

FIG. 11A-C are exploded views of a reader/heater subassembly for the biometric module of FIG. 1;

FIG. 12 is an exploded perspective view of a cover reader and sensor subassembly for the biometric module of FIG. 1;

FIG. 13 is a block diagram for a representative biometric module;

FIG. 14 is a generally operational flowchart for overall operation of a biometric module; and

FIG. 15 is an operational flowchart for temperature regulation for the biometric module.

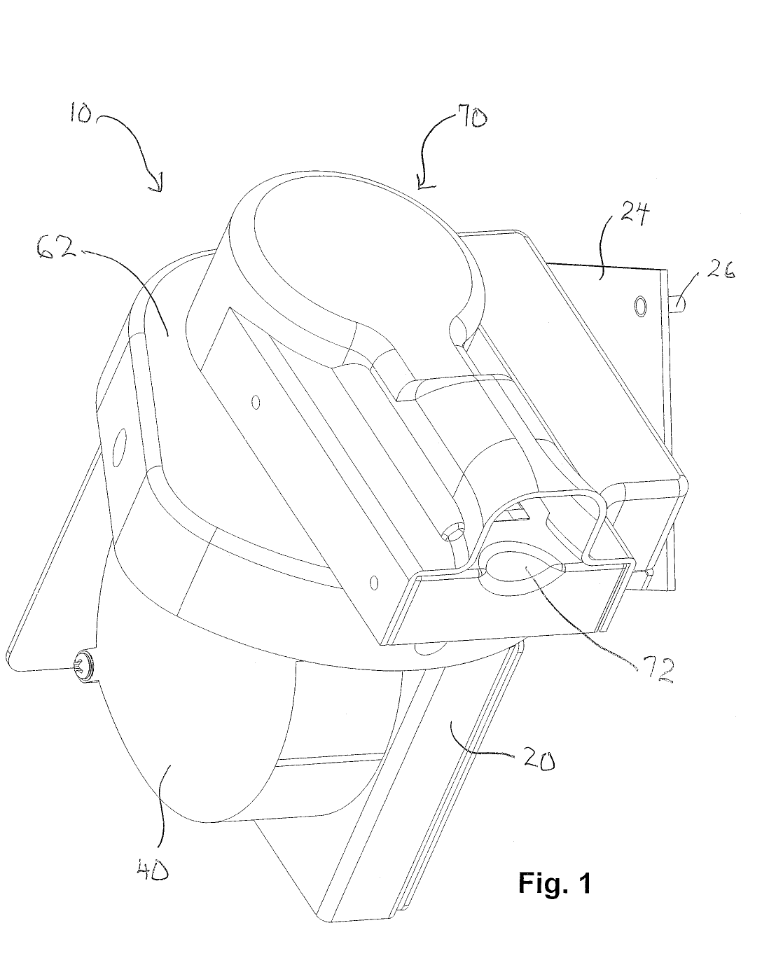

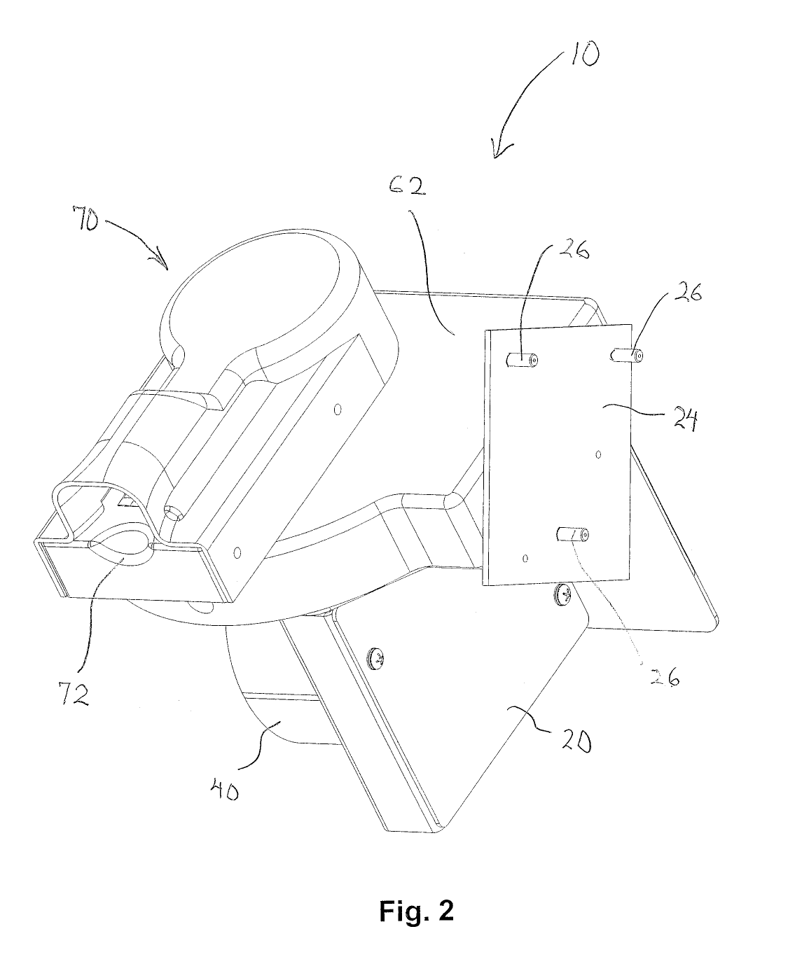

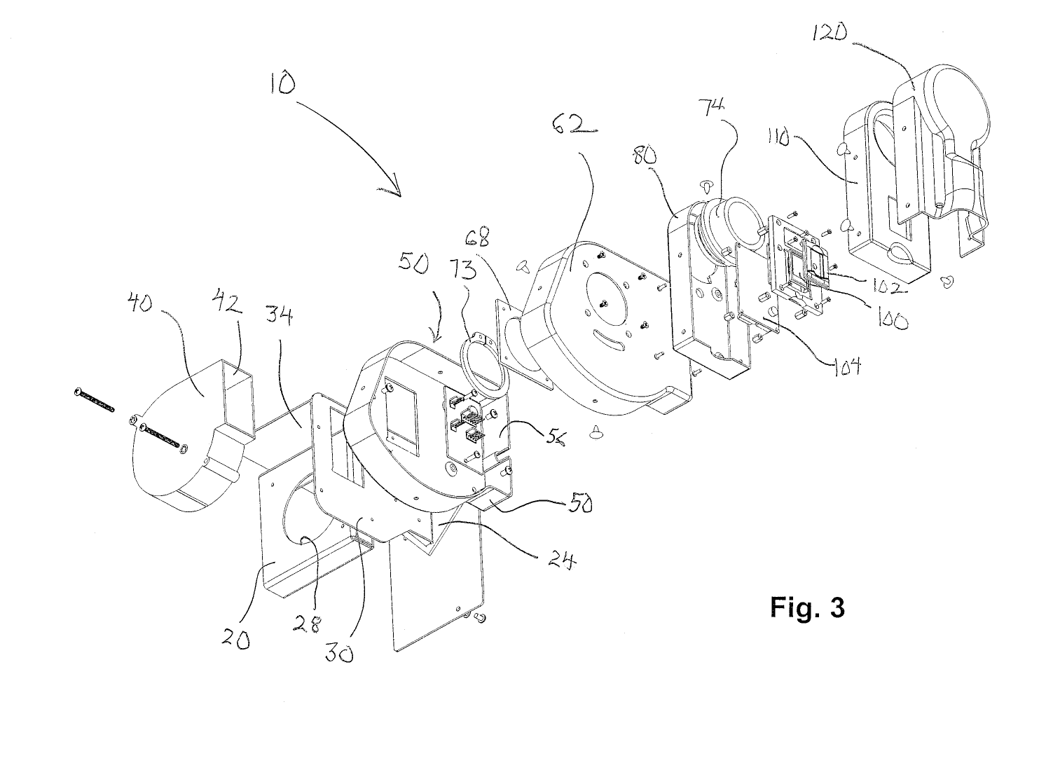

### DETAILED DESCRIPTION

With reference to the drawings wherein like numerals represent like parts throughout the several figures, a biometric module is generally represented by the numeral 10. The biometric module 10 incorporates an electronic fingerprint sensor which is readily accessible from an outdoor environment and includes auxiliary features for ensuring the integrity and efficient processing for biometric identification. The biometric module 10 is particularly adaptable for application in connection with controlling vehicle access to a secured facility by permitting a driver of the vehicle to access the electronic fingerprint sensor from the driver seat of the vehicle while the driver remains comfortably seated.

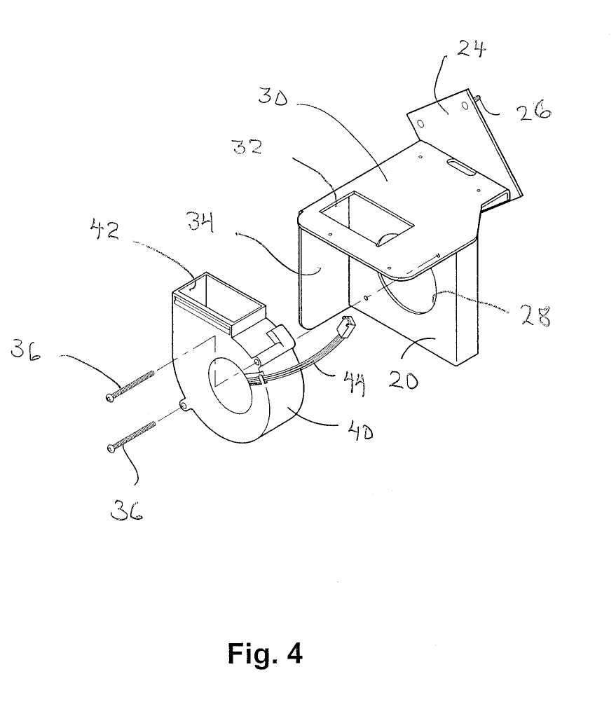

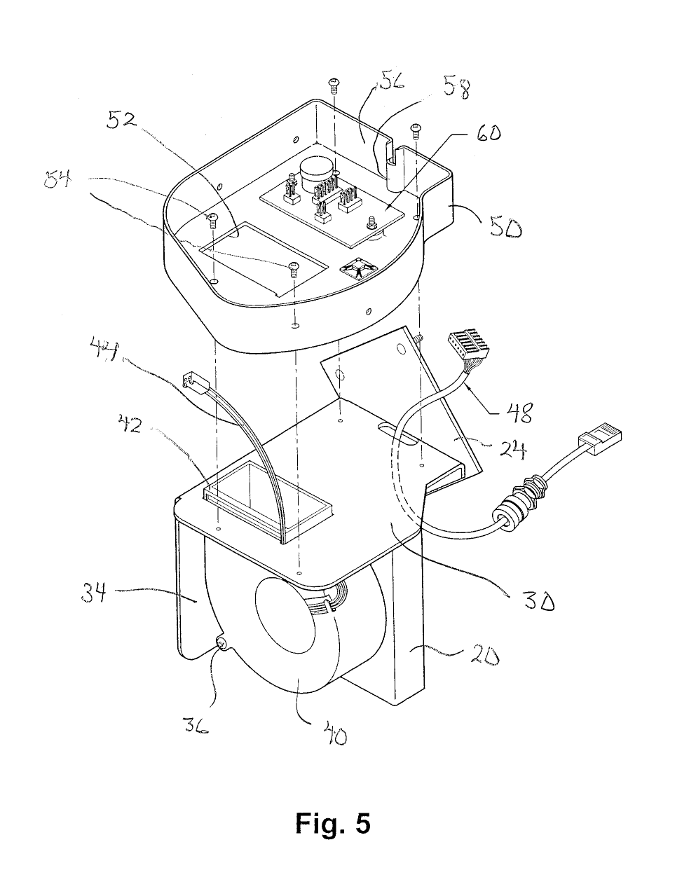

The biometric module 10 (FIG. 4) includes a main mounting bracket 20 which perpendicularly connects with an upper platform 30. The platform 30 includes a rectangular opening 32 and extends transversely to connect with a mounting plate 24. Fasteners 26 vertically mount the plate 24 to a pedestal or service tower (neither illustrated). The mounting bracket 20 includes a central opening 28 and a rear mounting support 34 which extends transversely at the underside of the platform 30.

A blower unit 40 includes a fan with a rotary housing having a generally rectangular output chute 42, the cross-sectional geometry of which is complementary with the opening 32. The blower unit 40 engages against the rear support 34 and is secured by bolts 35 to the upright mounting bracket 20. The output chute 42 extends upwardly through the platform 30. An electrical lead 44 extends from the blower unit 40.

A rear platform housing base 50 includes a floor with a rectangular opening 52 complementary with the blower output opening 42. The housing base floor 51 is positioned and attached to the platform 30 by screws 54 so that the terminus of the blower output chute 42 extends slightly above the floor. The housing base 50 has a side panel 56 with a pre-formed groove 58 to accommodate a power/communications cable 48. A portion of the frontal side has a curvelinear form which at a third side tapers rearwardly and connects with a generally rectilinear rear side. A blower heater controller board 60 is mounted slightly above the floor 51. The lead 44 from the blower unit 40 connects with the controller board 60. The power/communication cable 48 extends upwardly through a platform slot and the groove 58 and also connects with the controller board 60.

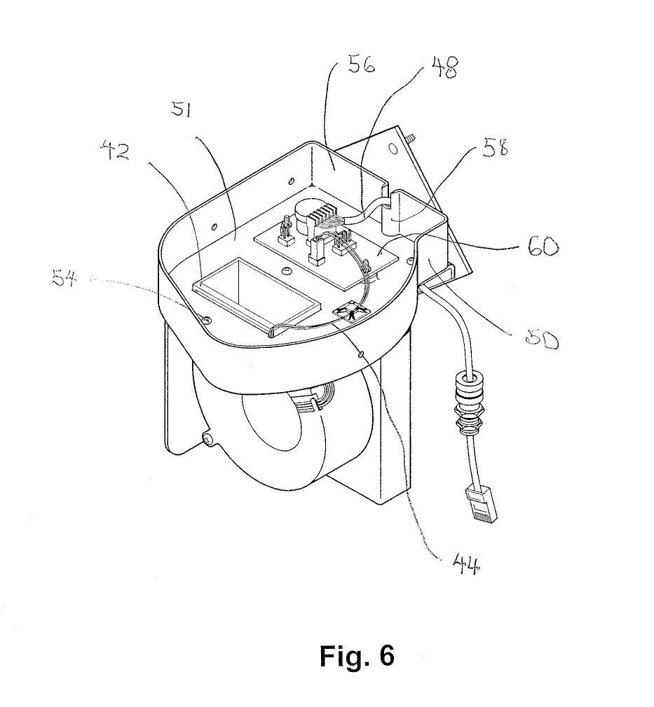

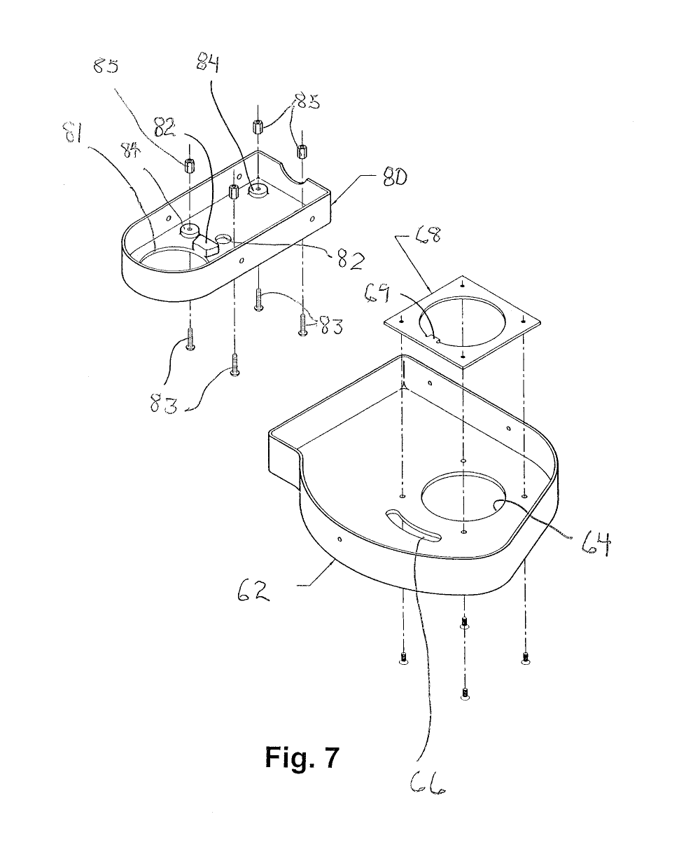

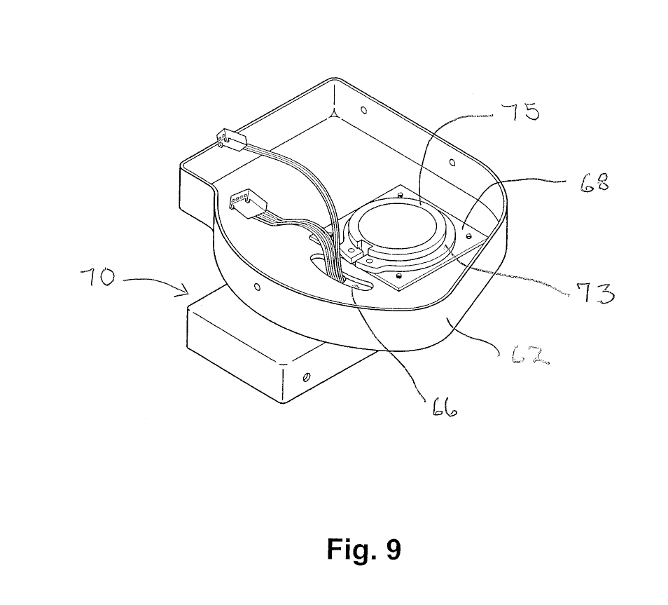

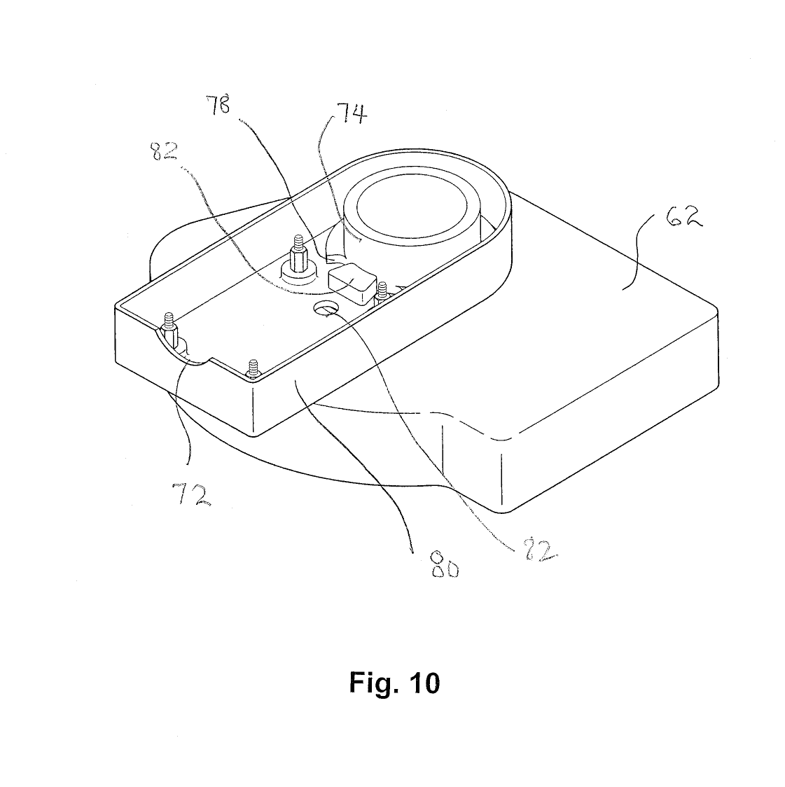

With additional reference to FIGS. 7-9, a housing cover 62 is dimensioned and shaped to generally closely fit over the reader housing base 50. The cover 62 as illustrated in FIGS. 7-9 is inverted and rotated to mount over the base 50 as illustrated in FIG. 6. The cover 62 includes a circular opening 64 and a coaxial arcuate wiring slot 66. A hub plate 68 with an anti-rotator key 69 is secured to the inside of the cover 62.

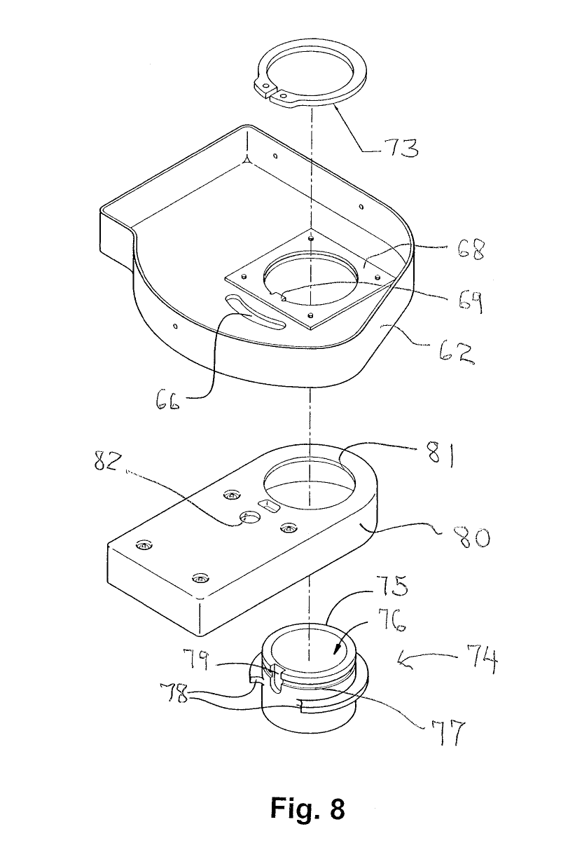

A rotatable reader case 70 rotatably mounts to the housing cover 62. The case 70 includes at one end an access slot 72. The other end receives a central rotator 74 with a hub 75 which couples with the housing to allow for limited pivotal rotation of the reader case 70 relative to the platform housing cover 62. The rotator 74 also functions to provide an air flow path. The rotator 74 includes a central cylindrical passage which defines an air flow channel 76. The rotator 74 includes an integral radial rim which defines radially spaced rotational limit key stops 78 (FIG. 8) at its outer periphery. An anti-rotation key seat 79 is formed in the upper portion of the rotator. The anti-rotation key 69 engages in the rotator seat 79 to prevent the rotator 74 from itself rotating.

The underside of a reader case base 80 includes a projecting rotational limit key 82 which engages between one of the key stops 78 of the rotator to define the range of rotation or pivoting. The rotator engages the underside of the base 80 so that the hub 75 extends through opening 64 and is secured by a retaining ring 73 seated in an exterior circumferential recess 77 of the hub 75.

The reader base 80 includes a central opening 81 which receives the hub 75. In addition, a smaller opening 82 provides an access opening. Fasteners 83 from the underside extend through bosses 84 which include spacers 85. The reader case includes the arcuate slot 66 to permit flexure and rotational movement of the cables extending from the reader case.

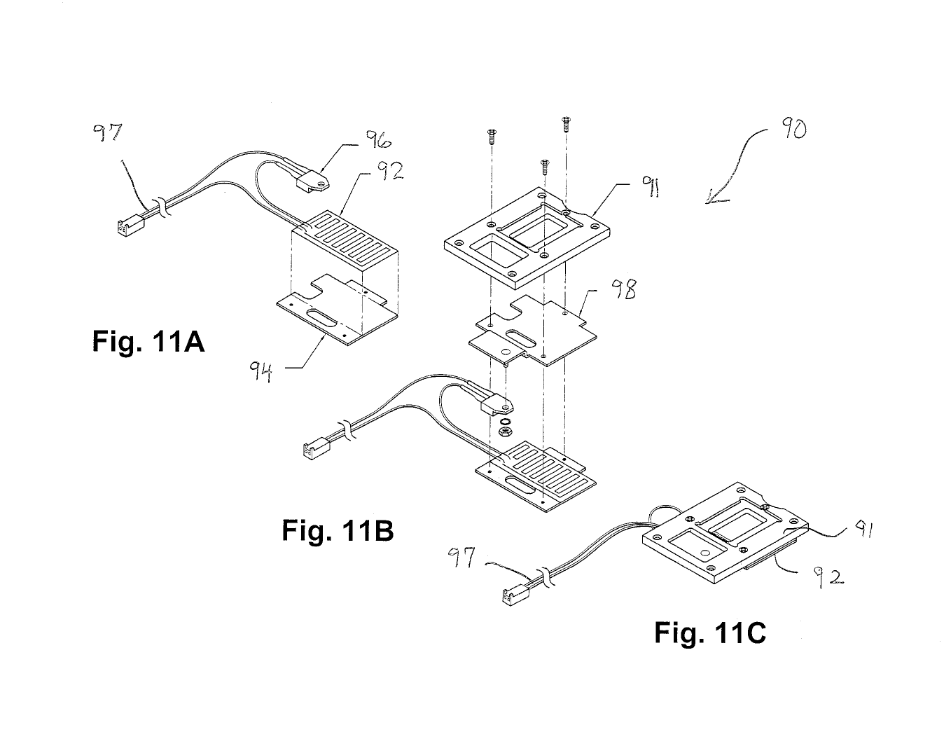

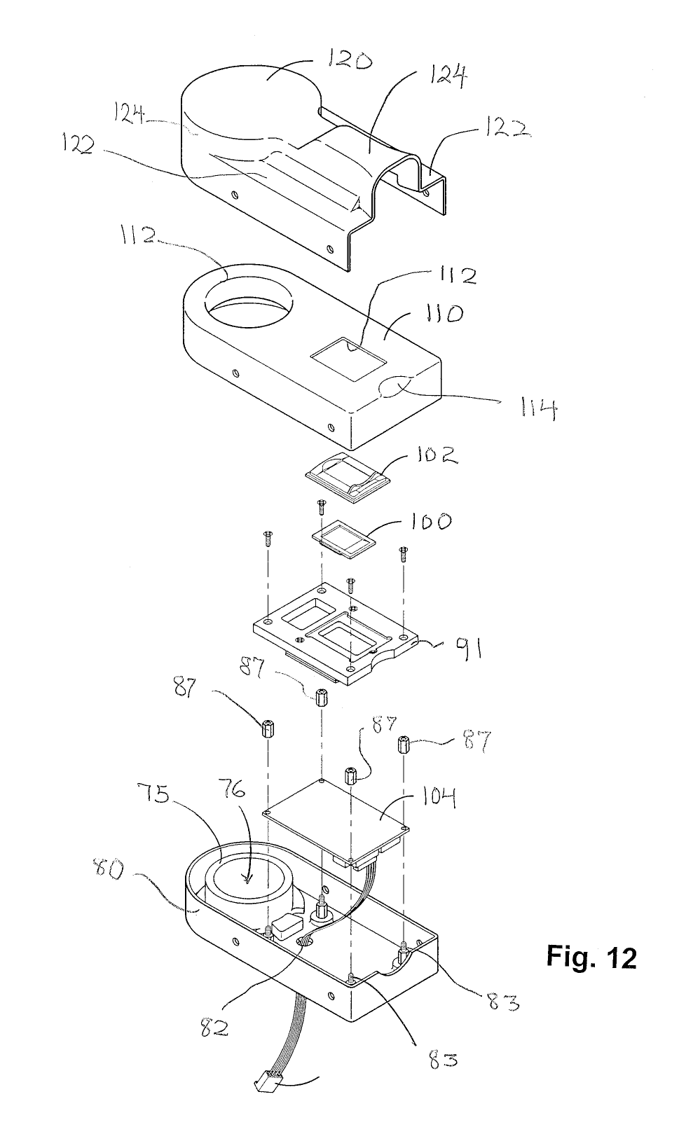

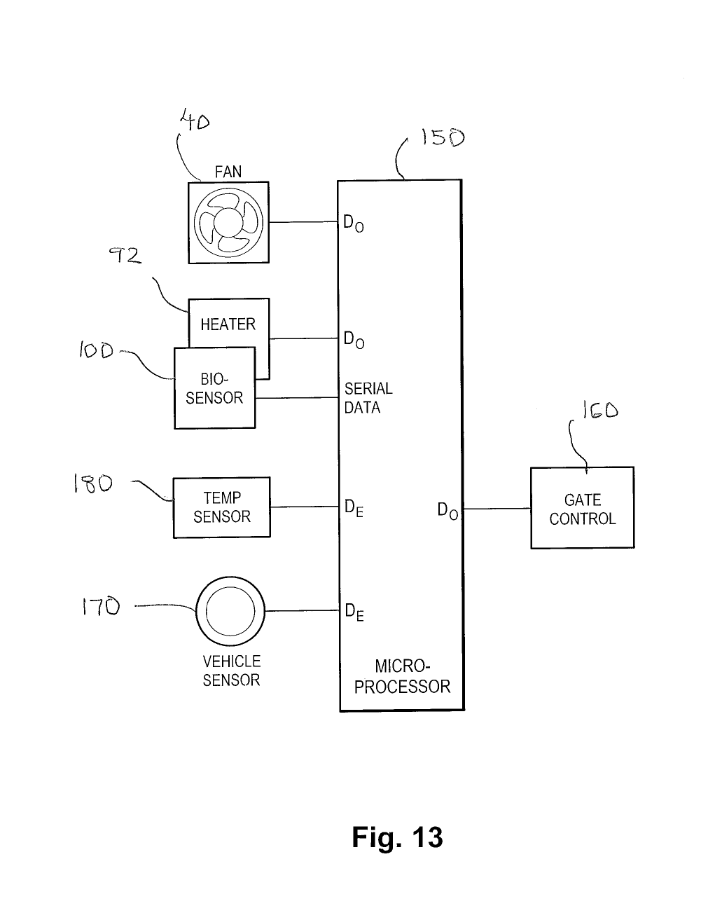

With additional reference to FIGS. 11A-C and 12, a heater sub assembly 90 for the reader case includes a heater 92 which mounts to a heater base plate 94. The heater 92 connects with a thermistor 96 and an electrical lead 97. A heat transfer plate mounts 98 over the heater and also captures the thermistor 96. A Teflon™ reader/heater frame 91 mounts over the heat transfer plate. The frame 91 includes a pair of rectangular openings. A reader element frame 102 mounts over a bio-reader element 100 which is received in the frame 91 mounted above a bio-reader controller card 104. The controller card 104 is secured by fasteners 83 which also threadably mount a second group of spacer nuts 87 that engage and support the frame 91 and the carried heater 92 and reader 100.

A reader case cover 110 fits over the reader base 80 and includes a circular opening 112 which engages around the rotator hub 75. A rectangular opening frames and allows surface access to the bio-reader element 100. A finger indentation 114 aligns with the slot 72 in the reader case. The reader 100 of case 70 is selectively rotatably positioned relative to the housing by virtue of the rotator connection which also provides a channel for the flow of air.

A transparent environmental case cover 120 mounts over the reader case cover 110. The case cover 120 includes a pair of frontal panel segments 122 which engage against the top of the case cover and a contoured central chute 124 which communicates with a generally cylindrical chamber 126. Chamber 126 is in direct communication with the blower channel 76 through the rotator and provides a flow of air across the bio-reader element 100. The chute 124 is dimensioned to readily allow the insertion of a finger into the chute so that the finger may engage the bio-reader element 100.

For a preferred application, the operation of the biometric module is controlled by a microprocessor 150 which generates an output to the gate control 160. The microprocessor receives a signal from a vehicle proximity sensor 170 as well as a temperature sensor 180. Serial data from the biosensor reader 100 is transmitted to the microprocessor 150. The microprocessor processes the signals and provides output signals to control the fan of the blower unit 40 and the heater 92. In addition, the microprocessor correlates the data from the reader 100 to either validate the sensed fingerprints or to indicate that access is not authorized. The authorized/not authorized signals are transmitted to the gate control 160.

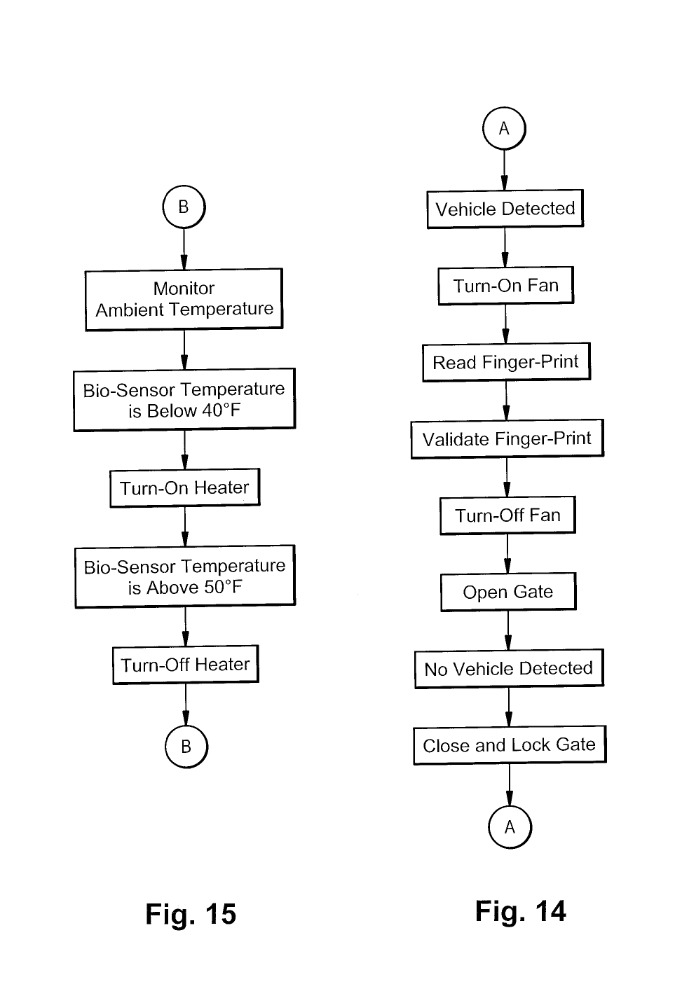

With reference to FIG. 14, the vehicle is detected and the blower unit fan is turned on. The fingerprint of the vehicle operator is placed on the reader 100 and then read. Upon validation, the blower fan is then turned off and the gate is opened. When no vehicle is detected, the gate is closed and locked. The forgoing operation is repeated as required.

With reference to FIG. 15, the ambient temperature is continuously monitored and controlled. The ambient temperature is monitored. For example, if the temperature is below 40° F., the heater is then turned on. Once the biosensor temperature exceeds 50° F., the heater is turned off. The forgoing cycle is repeated as the ambient conditions dictate. For some installations, other temperature ranges may be suitable.

The foregoing described biometric module 10 functions in a highly efficient manner. The reader case 70 may be selectively pivotally positioned to allow a user-friendly finger access to the reader. The reader 100 and various components are sealed against the environment to prevent the migration of moisture and the elements. The blower 40 is activated to emit an air stream which blows across the biosensor reader 100 to keep it contaminant free. In addition, the heater element 92 is employed to maintain a suitable temperature for the heating element and for the chute interior 124 so that the reader can be effectively and accurately used in all types of weather.

The biometric module 10 is preferably mounted to a post or service tower to provide ready access adjacent to a vehicle lane. The biometric module 10 can thus be employed by a driver while the driver is seated in a vehicle to gain access to a controlled vehicle facility.

1. A biometric module comprising:
a base assembly;
a cover assembly mounted to said base assembly and having a chute with an access opening at one end and being angularly pivotal relative to said base;
a bio-reader carried by said cover assembly and located adjacent said access opening; and
a blower for generating a flow of air through said chute and across said bio-reader.

2. The biometric module of claim 1 further comprising a heater for said bio-reader.

3. The biometric module of claim 1 further comprising a rotator which rotatably mounts said cover assembly to said base assembly and defines an air channel between said blower and said chute.

4. The biometric module of claim 2 and further comprising a temperature sensor for sensing ambient temperature, said heater being controlled in response to the ambient temperature.

5. The biometric module of claim 1 further comprising a microprocessor which receives data from said bio-reader and generates an output signal to a gate control.

6. The biometric module of claim 5 and further comprising a vehicle sensor which provides a vehicle detection input to said microprocessor, said blower being operated in response to said vehicle detection input.

7. The biometric module of claim 1 wherein said cover assembly and said base further comprise a limiter to limit angular pivoting of said cover assembly relative to said base.

8. The biometric module of claim 3 wherein the bio-reader is a fingerprint reader.

9. The biometric module of claim 1 wherein said cover assembly comprises a transparent cover.

10. A biometric module comprising:
a base assembly;
a cover assembly mounted to said base assembly and having a chute with an access opening at one end;
a bio-reader located adjacent said access opening;
a blower for generating a flow of air through said chute and across said bio-reader; and
a switch for actuating said blower.

11. The biometric module of claim 10 further comprising a heater for said bio-reader.

12. The biometric module of claim 11 and further comprising a temperature sensor for sensing ambient temperature, said heater being controlled in response to the ambient temperature.

13. The biometric module of claim 10 further comprising a microprocessor which receives data from said bio-reader and generates an output signal to a gate control.

14. The biometric module of claim 13 and further comprising a vehicle sensor which provides a vehicle detection input to said microprocessor, said blower being operated in response to said vehicle detection input.

15. The biometric module of claim 10 wherein the bio-reader is a fingerprint reader.
